(19) United States
(12) Patent Application Publication
(10) Pub. No.: US 2008/0286507 A1
(43) Pub. Date: Nov. 20, 2008

(54) Multilayer Film

(76) Inventors: Martin Dominic Smithson, Worcestershire (GB); Tien Tjiu Tan, East Java (ID)

Correspondence Address: HOGAN & HARTSON L.L.P., 1999 AVENUE OF THE STARS, SUITE 1400, LOS ANGELES, CA, 90067, US

(21) Appl. No.: 11/814,430

(22) PCT Filed: Jan. 20, 2006
(86) PCT No.: PCT/GB2006/000197

§ 371 Date: Mar. 5, 2008

(30) Foreign Application Priority Data
Jan. 21, 2005 (GB) 0501225.7

(51) Int. Cl. B32B 27/08; B32B 7/00; B32B 1/00; B65B 31/04

(52) U.S. Cl. 428/34.9; 428/517; 428/213; 53/432

(57) ABSTRACT

A multilayer film which loses its memory when subjected to heat shrinking comprising at least three layers, wherein at least one of the layers comprises a styrene-butadiene copolymer and the other layers comprise at least one material selected from the group consisting of HDPE, LLDPE and LDPE.

The present invention relates to a multilayer film.

Single layer plastics films are well known in the art. These films are used for a wide range of purposes such as plastic shopping bags and food packaging. While the known single layer films function satisfactorily in some applications there is a need for plastic films exhibiting properties not found in current allowable single layer films. Examples of some well known single layer films include High Density Polyethylene (HDPE), Linear Low Density Polyethylene (LLDPE), Low Density Polyethylene (LDPE) and Styrene Butadene Copolymers (SBC).

HDPE films are approved for use in the food industry. They have good mechanical property and exhibit some degree of toughness. In addition, products made of HDPE are recyclable and are economically viable.

LLDPE films also meet the criteria for approval for use in the food industry. They also have good mechanical property, are recyclable and are economically viable. In addition, they may be heat shrunk, that is they may be subjected to a heat source to shrink the film around a product for improved packaging.

LDPE is not approved for food use, however, it exhibits other properties not found in HDPE or LLDPE. LDPE films exhibit easy manual tear, are heat shrinkable and are recyclable. In addition, layers of the film are capable of bonding with each other upon heat exposure, without binding to any packaged contents. The films also exhibit good clarity which is a desirable feature in certain applications.

SBC films are also able to bind between themselves on exposure to heat without binding to the contents. In addition, they exhibit easy manual tear, are heat shrinkable, recyclable and have excellent clarity.

There is a need for a film which combines all of the features described in relation to the known single layer films. Further additional features are also desirable. Unfortunately, it has not proved possible to blend together known materials to achieve a suitable film. Blending the known plastics materials together results in a loss of the desired features, rather than combining them. For example, the polyolefins (HDPE, LLDPE and LDPE) can be mixed from a processing point of view but the resulting film does not exhibit improved features. It has not proved possible to blend the polyolefins with SBC. The resulting film becomes brittle, hazy and unable to perform satisfactorily.

There is a need to produce a film which combines a variety of features not currently available in a single layer plastics film. The characteristics required for the film are:
i) the film should meet the standards for use in the food industry i.e. must be non-toxic with no heavy metal content;
ii) it should have good mechanical property and some degree of toughness;
iii) it should have some degree of easy manual tear-ability and heat shrink-ability;
iv) it should have some degree of low slip on the outside and higher slip in the inside;
v) it should be able to maintain the pack integrity for use as transit packaging and/or display packaging;
vi) it should be recyclable;
vii) it should be able to bond between its own films and must not stick to the content;
viii) it should be affordable and offer better economics than corrugated carton;
ix) it should be able to be combined with different features such as UV resistance, flame retardance, anti-static (permanent or not) and/or conductivity; and
x) it should offer reasonable clarity/haze to enable the content to be seen.

One particular area where such a film would be desirable is as a flexible enclosure for use in the vacuum packaging of products. In particular, a film with the properties listed above would be particularly suitable for use with the vacuum packaging apparatus described in WO 02/083505, the contents of which are incorporated herein by reference.

The vacuum packaging apparatus disclosed in WO 02/083505 comprises means for evacuating air from within a flexible enclosure, means for compressing the enclosure prior to evacuation of the air and means for sealing sealable meeting portions of the unsealed enclosure, wherein the means for compressing the enclosure comprises a pressure plate mounted in a plane parallel to the plane of an opposed surface upon which the unsealed enclosure is disposed in use. The apparatus functions very well and results in the production of a neatly vacuum packed product. However, to a certain extent, the quality of the vacuum packed product is determined by the characteristics of the film which the enclosure is made of. The flexible enclosure must be capable of providing an airtight enclosure which is capable of being readily sealed e.g. by heat sealing. The enclosure is provided as a pre-formed pocket, preferably closed along a portion of the periphery to leave an open mouth for access to the interior and sealing.

When the air has been extracted from within the enclosure the open mouth is sealed and the package is complete, generally, this leaves a protruding flap of the enclosure material at the mouth of the bag. If this flap of material is punctured it will allow air to enter the enclosure thus destroying the integrity of the vacuum package product. Similarly, if the film is punctured at any other point it will allow air to enter the package, causing the package to expand and lose its vacuum packed shape.

It is the object of the present invention to overcome the problems of the prior art or at least to provide an alternative to currently sealable films.

According to the present invention there is provided a multilayer film which loses its memory when subjected to heat shrinking comprising at least three layers, wherein at least one of the layers comprises a styrene-butadiene copolymer and the other layers comprise at least one material selected from the group consisting of HDPE, LLDPE and LDPE.

The term “loses its memory”, as used herein, refers to the fact that the multilayer film does not return to its original shape once it has been subjected to heat shrinking. In effect, the film loses the memory of its original shape and maintains its new shape. Heat shrinking involves subjecting the film to a heat source in a shrink tunnel. The film shrinks around the contours of the packaged goods. This is an important features of the present invention, particularly with respect to the use of the film in vacuum packing. Vacuum packing of products has two main benefits: i) it prolongs the life of food products by providing a barrier, ii) it reduces transportation costs of compressible products. It is in relation to the second of these benefits that the multilayer film according to the present invention is particularly useful.

Compressible products can be defined as any product the size of which may be reduced by the application of a compression force. When the product is compressed air is forced out. In conventional vacuum packing the air is evacuated from the enclosure using a vacuum pump and the enclosure is then sealed, usually by means of a heat seal. This enables the product to be transported in its compressed form. If the enclosure is punctured air will be able to enter the enclosure and the vacuum packed product will expand to the maximum size permitted by the enclosure. However, if the enclosure is manufactured from a multilayer film according to the present invention and the vacuum packed product is subjected to heat shrinking after compression, air extraction and sealing of the enclosure then the vacuum packed product will not expand if the enclosure is punctured. This is because the multilayer film loses its memory when subjected to heat shrinking. Consequently, it does not attempt to return to its original shape when air enters the enclosure. The result is only a minimal increase in package size.

Preferably, an inner surface of the multilayer film adheres to a corresponding surface of film when heated. The two layers of film preferably adhere to one another without actually becoming sticky themselves. Consequently, the two layers of film will stick to one another, but not to other surfaces, such as goods which are being packed. This is particularly useful when the multilayer film is used to make an enclosure for vacuum packing goods. As described above, the product is compressed, air is evacuated from within the enclosure and the enclosure is heat sealed. Next the vacuum packed product is subjected to heat shrinking. This causes the enclosure to shrink around the product to form a neat package. Layers of multilayer film which come into contact stick together but the film does not stick to the product. A periphery of film is provided around the product as a result of its compression. In a conventional enclosure if the enclosure was punctured in the peripheral region air would get in and destroy the integrity of the package. However, if the enclosure is manufactured with a multilayer film according to the present invention then the layers of film in the peripheral region will adhere together. Thus, if the enclosure is punctured in the peripheral region, no air can enter the enclosure.

The multilayer film may comprise a layer comprising SBC sandwiched between an inner layer comprising LLDPE and an outer layer comprising LLDPE. Preferably, the film is a three layer film. The LLDPE may conveniently comprise a mixture of high-slip LLDPE and non-slip LLDPE or, alternatively, it may comprise only high-slip LLDPE. It is preferred that the LLDPE layers are provided with one or more additives. The additives may be selected from the group consisting of processing aids and anti-oxidants in an amount up to 1%.

Alternatively, the multilayer film may comprise an inner layer comprising SBC, a middle layer comprising LLDPE and an outer layer comprising HDPE. The LLDPE layer may conveniently comprise a mixture of high-slip LLDPE and non-slip LLDPE. The SBC layer may conveniently comprise high impact polystyrene. The high impact polystyrene may be present in an amount up to 5%.

As a further alternative, the multilayer film may comprise an inner layer comprising HDPE, a middle layer comprising LLDPE and an outer layer comprising SBC. The LLDPE layer may conveniently comprise a mixture of high-slip and non-slip LLDPE.

The SBC preferably has a density in the range from 0.98 to 1.20 g/cm³. The SBC preferably has a melt flow rate in the range from 5.0 to 10.0 g/10 min.

The HDPE preferably has a density in the range from 0.945 to 0.960 g/cm³. The HDPE preferably has a melt flow rate in the range from 0.02 to 0.10 g/10 min.

The LLDPE has a density in the range from 0.916 to 0.930 g/cm³ and a melt flow rate of 0.03 to 3.00 g/10 min.

The LDPE has a density in the range from 0.916 to 0.930 g/cm³ and a melt flow rate in the range 0.03 to 8.00 g/10 min.

The outer layer of the film preferably comprises from 10-45% of the total thickness of the film, the middle layer preferably comprises 10-80% of the total thickness of the film and the inner layer preferably comprises from 10-45% of the total thickness of the film. The film is preferably a three layer structure. The structure may be symmetrical about the middle layer, i.e. the inner and outer layers being the same width. Alternatively, the structure may be non-symmetrical, i.e. the inner and outer layers being of different thicknesses.

The multilayer film may also be a five layer structure. As with the three layer structure, the structure may be symmetrical or non-symmetrical about the middle layer.

According to a second aspect of the present invention there is also provided a method of vacuum packing a product in an enclosure comprising the following steps, in any suitable order:
i) placing the product within the enclosure;
ii) compressing the enclosure with the product inside;
ii) evacuating air from within the enclosure;
iv) sealing the open mouth of the enclosure with the product inside; and
v) subjecting the enclosure and product to heat treatment in a shrink tunnel.

The invention will now be described, by way of example, with reference to the following examples. The films are coextruded multilayer films and are manufactured using a conventional co-extrusion blown film production line such as the one manufactured by Reifenhauser GmbH & Co. KG Machinenfabrik. The films were formed into enclosures of the type used in vacuum packing and were tested for their suitability as such.

### EXAMPLE 1

A three layer film was produced by the blown film coextrusion method. The film comprised an outer layer of LLDPE, a middle layer of SBC and an inner layer of LLDPE. The inner and outer layers of LLDPE comprised 75% of Nova 9022D, a high-slip LLDPE manufactured by Nova Chemicals, and 25% of Nova 9022C, a non-slip LLDPE manufactured by Nova Chemicals. The SBC was K Resin KR05.

The first extruder, which forms the outer layer of the film was operated at 180° C. and at a screw pressure of 480 bar. The screw operated at 41 RPM.

The second extruder, which forms the middle layer of the film was operated at 190° C. and at a screw pressure of 300 bar. The screw operated at 57 RPM.

The third extruder, which forms the inner layer of the film was operated at 180° C. and at a screw pressure of 380 bar. The screw operated at 50 RPM. The speed of the nip roll was 28 m/min and the bubble neck was 80 cm.

The resulting film was a symmetrical film with a total thickness of 50 μm. The inner and outer layers were both 15 μm thick and the middle layer was 20 μm thick. The film was stable, exhibited some melt fracture and did not have good optical properties. However, the film lost its memory when subjected to heat shrinking in a shrink tunnel and layers of the film were capable of bonding to each other without bonding to any packaged goods within the enclosure.

### EXAMPLE 2

A three layer film was produced by the blown film coextrusion method. The film comprised an outer layer of LLDPE, a middle layer of SBC and an inner layer of LLDPE. The inner and outer layers comprised 74% of Nova 9022D, a high slip LLDPE, 25% of Nova 9022C, a non-slip LLDPE, and 1% of a processing aid and anti-oxidant. The SBC copolymer was K Resin KR05.

The first extruder, which forms the outer layer of the film, was operated at 200° C. and at a screw pressure of 480 bar. The screw operated at 41 RPM.

The second extruder, which form the middle layer of the film, was operated at 190° C. and at a screw pressure of 300 bar. The screw operated at 57 RPM.

The third extruder, which forms the inner layer of the film, was operated at 200° C. and at a screw pressure of 380 bar. The screw operated at 50 RPM. The speed of the nip roll was 25 m/min and the bubble neck was 80 cm.

The resulting film was a symmetrical film with a total thickness of 50 μm. The inner and outer layers were both 15 μm thick and the middle layer was 20 μm thick. The melt fractures present in the film of Example 1 were reduced. However, the film exhibited a tendency to stick together during manufacture which leads to production difficulties. It is believed the high loading of non-slip LLDPE causes the melt not to go out smoothly. It is believed that some amount of non-slip LLDPE is required to provide a film with non-slip properties. However, it appears that too much may be undesirable and the level will need to be determined on a case-by-case basis. When tested the film lost its memory when subjected to heat shrinking in a shrink tunnel and layers of the film were capable of bonding to each other without bonding to any packaged goods within the enclosure.

### EXAMPLE 3

A three layer film was produced by the blown film coextrusion method. The film comprised an outer layer of LLDPE, a middle layer of SBC and an inner layer of LLDPE. The inner and outer layers comprised 89% of Nova 9022D, a high-slip LLDPE, 10% of Nova 9022C, a non-slip LLDPE and 1% of a processing aid and an anti-oxidant. The SBC was K Resin KR05.

The first extruder, which forms the outer layer of the film, was operated at 195° C. and at a screw pressure of 453 bar. The screw operated at 41 RPM.

The second extruder, which forms the middle layer of the film, was operated at 190° C. and at a screw pressure of 236 bar. The screw operated at 40 RPM.

The third extruder, which forms the inner layer of the film, was operated at 195° C. and at a screw pressure of 405 bar. The screw operated at 40 RPM. The speed of the nip roll was 23 m/min and the bubble neck was 80 cm.

The resulting film was a symmetrical film with a total thickness of 50 μm. The inner and outer layers were both 15 μm thick and the middle layer was 20 μm thick. The film exhibited no melt fractures, but was still prone to sticking during manufacture. When tested, the film lost its memory when subjected to heat shrinking in a shrink tunnel and layers of the film were capable of bonding to each other without bonding to any packaged goods within the enclosure.

### EXAMPLE 4

In order to determine the effect of removing the non-slip LLDPE, a further three layer film was produced by the blown film co-extrusion method. The film comprised an outer layer of LLDPE, a middle layer of SBC and an inner layer of LLDPE. The inner and outer layers comprised 99% of Nova 9022D, a high-slip LLDPE and 1% of a processing aid and anti-oxidant. The SBC was K Resin KR05.

The first extruder, which forms the outer layer of the film, was operated at 195° C. and at a screw pressure of 453 bar. The screw operated at 41 RPM.

The second extruder which forms the middle layer of the film, was operated at 190° C. and a screw pressure of 236 bar. The screw was operated at 40 RPM.

The third extruder, which forms the inner layer of the film, was operated at 195° C. and a screw pressure of 405 bar. The screw was operated at 40 RPM. The speed of the nip roll was 23 m/min and the bubble neck was 80 cm.

The resultant film was a symmetrical film with a total thickness of 50 μm. The inner and outer layers were both 15 μm thick and the middle layer was 20 μm thick. The film exhibited no melt fractures and did not stick together during manufacture. In addition, the film was relatively soft and had good clarity. When subjected to heat in a shrink tunnel the film loses its memory and layers of film will adhere to each other without sticking to the goods which they surround.

### EXAMPLE 5

A three layer film was produced using the blown film co-extrusion method. The film comprised an outer layer of HDPE, a middle layer of LLDPE and an inner layer of SBC. The outer layer comprised 100% of the high molecular weight polyethylene El-ene F15, manufactured by Cementhai Chemicals. The middle layer comprised a mixture of 50% of the high-slip Nova 9022D and 50% of the non-slip Nova 9022C. The inner layer comprised 98% of K Resin KR05 and 2% of the high impact polystyrene Idemitsu HH30, manufactured by Idemitsu Petrochemical.

The first extruder, which forms the outer layer of the film, was operated at 205° C. and at a screw pressure of 478 bar. The screw operated at 20.1 RPM.

The second extruder, which forms the middle layer of the film, was operated at 195° C. and at a screw pressure of 408 bar. The screw operated at 68.6 RPM.

The third extruder, which forms the inner layer of the film, was operated at 190° C. and at a screw pressure of 213 bar. The screw operated at 23.9 RPM. The speed of the nip roll was 25 m/min and the bubble neck was 110 cm.

The resultant film was a symmetrical film with a total thickness of 50 μm. The inner and outer layers were both 10 μm thick and the middle layer was 30 μm thick. The bubble was stable and the film had good clarity. However, there was a tendency for the film to stick together during manufacture. When subjected to heat in a shrink tunnel the film loses its memory and layers of the film will adhere to one another without sticking to the goods being packaged.

### EXAMPLE 6

A three layer film was prepared according to the operating parameters of Example 5. The composition of the film was identical to that of Example 5 with the exception that the high impact polystyrene content in the inner layer was increased to 3%.

The bubble was stable, the film was less prone to sticking during manufacture and it had reasonable clarity. It appears as though the increased high impact polystyrene content aids the processability of the film. The film lost its memory when heated in a shrink tunnel and it was able to adhere to itself but not to the goods when used as a vacuum packing enclosure.

### EXAMPLE 7

A three layer film was prepared according to the operating parameters of Example 5. The composition of the film was identical to that of Example 5 with the exception that the high impact polystyrene content in the inner layer was increased to 4%.

The bubble was stable. The resultant film was less prone to sticking than the films of Examples 5 and 6. The clarity of the film was less than that of those of Examples 5 and 6, although it was still reasonably see-through. The film lost its memory when subjected to heat in a shrink tunnel and it was able to adhere to itself but not to any goods which it was surrounding.

### EXAMPLE 8

A three layer film was prepared according to the general structure of Examples 5, 6 and 7. However, the high impact polystyrene content of the inner layer was increased to 5%.

The first extruder, which forms the outer layer of the film, was operated at 205° C. and at a screw pressure of 513 bar. The screw operated at 24 RPM.

The second extruder, which forms the middle layer of the film, was operated at 195° C. and at a screw pressure of 417 bar. The screw operated at 70.4 RPM.

The third extruder, which forms the inner layer of the film, was operated at 185° C. and at a screw pressure of 262 bar. The screw operated at 36.5 RPM. The speed of the nip roll was 20 mm/min and the bubble neck was 110 cm.

The resultant film had a stable bubble, was less prone to sticking during manufacture but the clarity was not as good as the films of Examples 5-7. It appears as though high impact polystyrene improves the processability of the film at the expense of the appearance. Thus, the composition of the film must be selected based on consideration about its end use. For example, if it is to be used to package goods which must be seen in the package then the amount of high impact polystyrene must be limited. Alternatively, if the packaging is merely for transportation then higher levels of high impact polystyrene may be used. As with the films of Examples 5-7, the film loses its memory when subjected to heat in a shrink tunnel and it will stick to itself but not to the goods which it surrounds.

### EXAMPLE 9

A three layer film was prepared using the blown film co-extrusion method. The film comprised an outer layer of SBC, a middle layer of LLDPE and an inner layer of HDPE. The outer layer comprised 100% of K Resin KR10. The middle layer comprised a mixture of 50% of the high-slip LLDPE made by Exxon Mobil and sold as 1001XV and 50% of the non-slip LLDPE made by Exxon Mobil and sold as 1001KW. The inner layer comprised 100% of the HDPE sold under the brand Hizex 7000F.

The first extruder, which forms the outer layer of the film, was operated at 200° C. and at a screw pressure of 342 bar. The screw operated at 30 RPM.

The second extruder, which forms the middle layer of the film, was operated at 200° C. and at a screw pressure of 349 bar. The screw operated at 53 RPM.

The third extruder, which forms the middle layer of the film, was operated at 200° C. and at a screw pressure of 571 bar. The screw operated at 54 RPM. The speed of the nip roll was 41 m/min and the bubble neck as 100 cm.

The resultant film was a non-symmetrical film with a total thickness of 50 μm. The outer layer and middle layer were 17 μm thick and the inner layer was 16 μm thick. The bubble was stable and the film exhibited some curling in the direction of the SBC layer. When subjected to heat in a shrink tunnel the film loses its memory and layers of the film were able to adhere to one another without sticking to the goods being packed.

### EXAMPLES 10-11

In order to demonstrate the effect that the manufacturing parameters had on the film two further examples were prepared using the film composition of Example 9 with different manufacturing parameters.

In Example 10 the first extruder was operated at 200° C. with a screw pressure of 286 bar and a screw speed of 30 RPM. The second extruder was operated at 205° C. with a screw pressure of 237 bar and a screw speed of 40 RPM. The third extruder was operated at 205° C. with a screw pressure of 479 bar and a screw speed of 50 RPM. The speed of the nip roll was 27 m/min and the bubble neck was 100 cm.

The resultant film had a stable bubble and exhibited less curling than that of Example 9.

In Example 11 the first extruder was operated at 200° C. with a screw pressure of 237 bar and a screw speed of 30 RPM. The second extruder was operated at 205° C. with a screw pressure of 105° C. and a screw speed of 35 RPM. The third extruder was operated at 205° C. with a screw pressure of 240 bar and a screw speed of 50 RPM. The speed of the nip roll was 27 m/min and the bubble neck was 100 cm.

The resultant film had a stable bubble and did not curl towards the SBC layer.

All of the multilayer films in Examples 1-11 are suitable for use in food related applications. In addition, they are particularly suited for use as enclosures for vacuum packing. During manufacture of the film the bubble is flattened to create a tube of film. The tube may be slit down one side to produce a sheet of film or it may be sealed across the width of the film to make individual enclosures which may be used as bags or vacuum packing pouches.

The layers of the film may be treated during production to impart a range of potentially desirable characteristics to it, depending on the intended use. Such characteristics can include low slip, opacity, resistance to ultra-violet light, water resistance, air moisture resistance, biodegradability, pest repellency (including dog and bird repelling), fragrancing and colour change after a certain age (to indicate expiry of shelf life of the packed product).

1. A multilayer film which loses its memory when subjected to heat shrinking comprising at least three layers, wherein at least one of the layers comprises a styrene-butadiene copolymer and the other layers comprise at least one material selected from the group consisting of HDPE, LLDPE and LDPE.

2. A multilayer film according to claim 1, wherein an inner surface of the film adheres to a corresponding surface of film when heated.

3. A multilayer film according to claim 1, wherein the film comprises a layer comprising SBC sandwiched between an inner layer comprising LLDPE and an outer layer comprising LLDPE.

4. A multilayer film according to claim 3, wherein the LLDPE comprises a mixture of high slip LLDPE and non-slip LLDPE.

5. A multilayer film according to claim 3, wherein the LLDPE comprises only high slip LLDPE.

6. A multilayer film according to claim 4, wherein the inner layer and the outer layer comprise one or more additives.

7. A multilayer film according to claim 6, wherein the or each additive is selected from the group consisting of processing aids and antioxidants.

8. A multilayer film according to claim 6, wherein the or each additive is present in an amount up to 1%.

9. A multilayer film according to claim 1, wherein the film comprises an inner layer comprising SBC, a middle layer comprising LLDPE and an outer layer comprising HDPE.

10. A multilayer film according to claim 9, wherein the middle layer comprises a mixture of high-slip LLDPE and non-slip LLDPE.

11. A multilayer film according to claim 9, wherein the inner layer comprises high impact polystyrene.

12. A multilayer film according to claim 11, wherein the high impact polystyrene is present in an amount up to 5%.

13. A multilayer film according to claim 1, wherein the film comprises an inner layer comprising HDPE, a middle layer comprising LLDPE and an outer layer comprising SBC.

14. A multilayer film according to claim 13, wherein the middle layer comprises a mixture of high slip LLDPE and non-slip LLDPE.

15. A multilayer film according to claim 1, wherein the SBC has a density in the range from 0.980 to 1.20 g/cm³.

16. A multilayer film according to claim 1, wherein the SBC has a melt flow rate in the range from 5.0 to 10.0 g/10 min.

17. A multilayer film according to claim 1, wherein the HDPE has a density in the range from 0.945 to 0.960 g/cm³.

18. A multilayer film according to claim 1, wherein the HDPE has a melt flow rate in the range from 0.02 to 0.10 g/10 min.

19. A multilayer film according to claim 1, wherein the LLDPE has a density in the range from 0.916 to 0.930 g/cm³.

20. A multilayer film according to claim 1, wherein the LLDPE has a melt flow rate of 0.03 to 3.00 g/10 min.

21. A multilayer film according to claim 1, wherein the LDPE has a density in the range from 0.916 to 0.930 g/cm³.

22. A multilayer film according to claim 1, wherein the LDPE has a melt flow rate in the range 0.03 to 8.00 g/10 min.

23. A multilayer film according to claim 1, wherein the outer layer comprises from 10-43% of the total thickness of the film, the middle layer comprises from 10-80% of the total thickness of the film and the inner layer comprises from 10-45% of the total thickness of the film.

24. An enclosure in the form of a preformed pocket having an open mouth and closed sides, the enclosure being formed from a multilayer film according to claim 1.

25. A method of vacuum packing a product in an enclosure according to claim 24 comprising the following steps, in any suitable order:
i) placing the product within the enclosure;
ii) compressing the enclosure with the product inside;
iii) evacuating air from within the enclosure;
iv) sealing the open mouth of the enclosure with the product inside; and
v) subjecting the enclosure and product to heat treatment in a shrink tunnel.
